(19) United States
(12) Patent Application Publication
(10) Pub. No.: US 2017/0270818 A1
(43) Pub. Date: Sep. 21, 2017

(54) Simulation creates a novel Dual Task Paradigm ("Divided Attention") with enhanced fidelity with dynamic environments for injury reduction, performance enhancement, and rehabilitation

(71) Applicant: Barry James French, Bay Village, OH (US)

(72) Inventor: Barry James French, Bay Village, OH (US)

(21) Appl. No.: 15/075,628

(22) Filed: Mar. 21, 2016

(51) Int. Cl. G09B 19/00; G09B 5/02

(52) U.S. Cl. CPC G09B 19/003; G09B 5/02

(57) ABSTRACT

In the field of experimental psychology, a “dual-task paradigm” is defined as a task that requires the subject to perform two tasks simultaneously, so that this effort can be compared to his/her performance under single-task conditions.

Dual Task paradigms are frequently employed in research and healthcare to assess the cognitive and motor performance/status of an individual. Dual Task activities are integral to sport and other dynamic environments as the athlete's focus is often divided between cognitive and neuromuscular/musculoskeletal (“motor”) tasks.

Known DT paradigms fail to replicate the challenges of actual sports; nor do they generate certain fundamental analytics/metrics regarding sports performance under realistic conditions. Simulation creates a novel DT paradigm to detect and manage conditions that may predispose active subjects to increased risk of overtraining, as well movement asymmetries that may expose one to increased risks of brain or orthopedic injuries.

### RELATED U.S. APPLICATION DATA

U.S. Pat. No. 9,078,598, U.S. patent application Ser. No. 14/077,619, Provisional application No. 62/284,932 filed Oct. 14, 2015, U.S. Provisional Application No. 62/177,784 filed Mar. 20, 2015, and Ser. No. 14/614,702 filed Feb. 5, 2015.

### BACKGROUND OF THE INVENTION

1. Field of the Invention

This invention is in the field of physical performance evaluation devices and methods using Dual Task (DT) Paradigms. In the field of experimental psychology, a “dual-task paradigm” is defined as a task that requires the subject to perform two tasks simultaneously, so that this effort can be compared to his/her performance under single-task conditions. There is wide spread recognition for the utility of DT paradigms in both assessing the risk of injury and the recovery from injury or disease that includes athletic and weight-bearing aging populations.

### SUMMARY OF THE INVENTION

“In everyday life, we rarely perform only one task at a time. Rather, our day-to-day activities frequently involve the simultaneous performance of two or more tasks, such as walking and talking, or walking while searching for something in a pocket, referred to as dual-tasking. Given that attention is a limited resource, dividing attention between two concurrent tasks can result in a decrement in performance in one or both of the tasks, relative to when each task is performed alone . . . ”

The relative change in performance associated with dual-tasking is referred to as dual-task interference or the dual-task effect (DTE). Individuals with neurological deficits may be particularly susceptible to dual-task interference, because the relative increase in attentional demands to control motor performance means that there are fewer attentional resources available for simultaneous performance of secondary tasks.” Plummer et al, “Measuring treatment effects on dual-task performance: a framework for research and clinical practice.”

The foundation of the present invention is the recognition that persons moving within their environment, whether athletes on the field or court or geriatric patients ambulating across their room, must, based on visual observation, navigate/negotiate their movement path. And in many cases, they must also simultaneously “modulate/control”, either consciously or subconsciously, the rate in which they so move. These two distinct challenges are requisite to arriving at the correct direction at the correct time, and are consistent with the definition of a DT paradigm.

The assessment and rehabilitation of populations with movement disorders resulting from neurological or orthopedic disorders benefit from the application of dual task assessments that more accurately recreation real world challenges.

It is our supposition that a DT paradigm with improved measurement capabilities and enhanced fidelity with real world events will demonstrate improved sensitivity for the detection of increased risk for brain and orthopedic injuries as well as as for the symptoms of Overtraining Syndrome. This same DT paradigm may also serves a an effective performance enhancement and training device.

2. Description of the Related Art

In the field of experimental psychology, a “dual-task paradigm” (“DT paradigm”) is defined as a task that requires the subject to perform two tasks simultaneously, so that this effort can be compared to his/her performance under single-task conditions. Dual Task paradigms are frequently employed in both research and healthcare environments to assess the cognitive and motor performance/status of an individual who may, by way of example, has suffered a concussion (brain injury) or other neuromuscular “insult”, orthopedic injury or similar. A real world example of a DT paradigm is driving a car; the driver must concentrate on navigating her car down the road while simultaneously maintaining the prescribed speed limit.

Known DT paradigms fail to recreate the cognitive and three dimensional motor/movement challenges of dynamic environments that include sports as well as other physically challenging environments. And known DT paradigms do not provide the metrics/analytics sufficiently sensitive to characterize a subject's cognitive and motor capabilities to detect an increased risk of injury or of overtraining. It is believed that an improved DT paradigm, one with novel analytics having enhanced measurement sensitivity may improve the detection of the signs of overtraining syndrome as well as an increased risk of orthopedic and brain injuries in broad populations.

Present DT approaches include, by way of example, the subject walking up stairs while tasked with counting down by 3 s out loud. While this DT approach provides two distinct tasks, i.e., the walking up stairs and the “distraction” of counting down out loud, it fails to accurately replicate the cognitive, motor and cardiorespiratory challenges inherent in reaction-based sports as well as other physically demanding weight-bearing activities. Accordingly such approaches fail to provide the data/analytics to more fully characterize the subject's capabilities.

An abundance of research supports the value of a DT paradigm in the sports environment. “Participation in sport requires divided attention, because it involves rapid simultaneous processing of cognitive, motor and sensory information in order to carry out specified tasks. Because divided attention is required for sport, it is imperative that the role of divided attention tasks in the return to play progression following sport-related concussion be identified.” (Footnote 4—“FN4”)

The scientific literature acknowledges a “lack of ecological validity with current DT paradigm methodologies: “The tasks employed in more traditional forms of DT methodology were simple laboratory tasks, often involving measures of reaction time. Although these tasks provided an informative insight into human brain function, they have been limited in their real-life applications and are suggested to lack ecological validity to real world situations such as a sportsperson may be engaged in. More recently, studies have evolved this paradigm to incorporate gross motor function tasks such as gait, and cycling in keeping with much of our everyday activities while expanding its applications in sports research. This approach is interesting for sports medicine personnel as it has the potential to identify subtle physical and cognitive impairments which may not be currently detected by traditional assessment strategies.” FN 2

The paper “Are Divided Attention Tasks Useful in the Assessment and Management of Sport-Related Concussion?” offered “However, logically incorporating directed divided attention tasks into the return to play process may help improve performance. Participation in sport requires divided attention, because it involves rapid simultaneous processing of cognitive, motor and sensory information in order to carry out specified tasks. Because divided attention is required for sport, it is imperative that the role of divided attention tasks in the return to play progression following sport-related concussion be identified.”

“Overall, divided attention tasks involving cognition and postural control tasks may refine the assessment of concussion and identify compromised processes requiring healing and rehabilitation. Assessment of divided attention may give timely and relevant information to clinicians, as all aspects of sport require adequate and precise motor control in the presence of numerous cognitive demands. The current concussion evaluation paradigm does not include objective assessments in this capacity.” FN4 This reference to “postural control” refers to static balance assessing devices; a class of devices that fail to either prompt/elicit or assess 3-dimensional movements; nor do they account for the effects of increase metabolic (heart) rates.

“Sports-related concussions are often diagnosed using a battery of tests, including clinical evaluations, cognitive functioning, postural control, and self-reported symptoms. While single-task paradigms effectively measure either cognitive functioning or postural control, these paradigms may be limited as they only evaluate domains in isolation and not the interaction of these domains across concurrent tasks. Performance in sport requires simultaneous processing of cognitive, sensory, and motor information. A paradigm including concurrent assessments of these domains is needed to understand capabilities related to complex tasks. The closest suggested paradigm that clinicians have to replicate real sports scenarios while concurrently evaluating concussive effects is a dual-task methodology incorporating cognitive and balance demands. Post-concussive testing should simulate the demands of sport in order to make informed return-toplay decisions. Dual-task paradigms have been described in recent literature. However, the cognitive tasks used are limited in their difficulty compared to the incongruent Stroop task, which involves inhibitory and interference processes.” Balance and cognitive performance during a dual-task: Preliminary implications for use in concussion assessment. Again this quote provide further evidence of the perceived value of DT paradigms in return to play scenarios. That said, a Stroop task has the subject walk by a sign with certain words printed on it to be read aloud. It too fails to replicate the demands of actual sports or measure fundamental aspects of subject movement in game play.

The present invention challenges cognitive function, which is measured via reaction time and the resulting “correctness” (compliance with) of both the distance and direction the subject elects to move to satisfy the visual cues dictating the prescribed movement rate and direction. The present invention elicits movement from the subject that more accurately replicates/simulates the type of 3-dimensional movement of real sport; movement that is more complex than the “postural control” practiced in tests of static balance.

There is a recognized need for improved DT paradigms to assist in managing exercise programs to detect signs of overtraining and heightened risk of injury:

“Athletes and the field of sports medicine in general would benefit greatly if a specific, sensitive simple diagnostic test existed for the diagnosis of OTS.” This was the conclusion of the seminal consensus statement titled “Prevention, Diagnosis, and Treatment of the Overtraining Syndrome: Joint Consensus Statement of the European College of Sport Science and the American College of Sports Medicine” (FN 1)

“There is still a strong demand for relevant tools for the early diagnosis of OTS. OTS is characterized by a ‘sport-specific’ decrease in performance together with disturbances in mood state.” FN 1 the present invention uniquely capable of measuring “sport specific” performance.

“Overtraining syndrome (OTS) is a major threat for performance and health in athletes. OTS is caused by high levels of (sport-specific) stress in combination with too little regeneration, which causes performance decrements, fatigue and possibly other symptoms.” (FN 10)

The paper “A New Way to Predict and Prevent Athletic Injury” listed a number of non-sport specific methodologies that attempted to predict injury risk. “Researchers have proposed several other approaches to predict performance and injury risk in apparently healthy players, including direct current potential of the brain; amplitude frequency analysis of electrocardiograms; psychological questionnaires; biochemical markers; imaging; balance or proprioception; isokinetic muscle testing; and analysis of risk factors such as previous injury, fatigue, and muscle imbalance.” FN 3

“But it seems that physicians hoping to advise their patients will have to wait a few years before they can be sure about which of these approaches to predicting injury actually work.” FN 3 It is notable that none of these tests characterize global athletic performance.

“A hallmark feature of the OTS is the inability to sustain intense exercise, a decreased sports-specific performance capacity when the training load is maintained or even increased.” Urhausen et al., 1995; Meeusen et al., 2004.

“Successful training not only must involve overload but also must avoid the combination of excessive overload plus inadequate recovery.” FN1 Key definitions include:
“Overreaching—an accumulation of training and/or non-training stress resulting in short-term decrement in performance capacity with or without related physiological and psychological signs and symptoms of maladaptation in which restoration of performance capacity may take from several days to several weeks.” FN1
“Overtraining—an accumulation of training and/or non-training stress resulting in long-term decrement in performance capacity with or without related physiological and psychological signs and symptoms of maladaptation in which restoration of performance capacity may take several weeks or months.” FN1

“Although in recent years the knowledge of central pathomechanisms of the OTS has significantly increased, there is still a strong demand for relevant tools for the early diagnosis of OTS. The OTS is characterized by a “sports-specific” decrease in performance . . . ” FN1

The fundamental weakness of current methodologies is the inability to measure “performance; “Early and unequivocal recognition of OTS is virtually impossible because the only certain sign is a decrease in performance during competition or training.” FN 1

In fact, “some scientists have suggested that the OTS be renamed as the unexplained underperformance syndrome that focuses on the key symptom of underperformance in OTS rather than on the mechanisms.” FN 1

“In athletes who have been diagnosed as having OTS, several signs and symptoms have been associated with this imbalance between training and recovery. However, reliable diagnostic markers for distinguishing between well-trained athletes, OR athletes, and athletes having OTS are lacking. A hallmark feature of OTS is the inability to sustain intense exercise, a decreased sport-specific performance capacity when the training load is maintained or even increased . . . . The key indicator of OTS can be considered an unexplainable decrease in performance. Therefore, an exercise/performance test is considered to be essential for the diagnosis of OTS.” FN 1

“It appears that both the type of performance test used and the intensity/duration of the test are important in determining the changes in performance associated with OTS. Debate exists as to which performance test is the most appropriate when attempting to diagnose OR and OTS. In general, time-to-fatigue tests will most likely show greater changes in exercise capacity as a result of OR and OTS than incremental exercise tests.” FN 1 Both embodiments taught act to induce fatigue in the subject leading to volitional termination in many instances.

“To detect subtle performance decrements, it might be better to use sport-specific performance tests. Tests of high-intensity exercise performance may be appropriate in some sports.” FN 1

It has been speculated that 80% of the information gleaned from the environment is visual; measuring isolated capacities says nothing about the athlete's “sport-specific” performance capabilities to respond to what is seen or how the body is mobilized into action. Essentially the linkage between the visual, cognitive and neuromuscular systems is fundamental for the successful interaction within a dynamic sport's environment.

The present invention exploits novel sports simulation to replicate the dynamic environment of reaction-based sports for a more sensitive, objective and accurate D.T. paradigm of actual sports. This enhanced sensitivity is requisite to the detection of signs of overtraining syndrome as well as heightened risk of orthopedic and brain injuries.

The present invention provides enhanced sensitivity and novel analytics for detecting signs of overtraining syndrome and increased risk of orthopedic and brain injuries.

The present invention exploits sport simulation incorporating a novel Dual Task (“divided attention”) Paradigm that more profoundly challenges the athlete's sensory, cognitive and motor prowess resulting in enhanced measurement sensitivity and relevance for exercise prescription management and injury prevention.

### BRIEF DESCRIPTION OF THE DRAWINGS

The annexed drawings, which are not necessarily to scale, show various aspects of the invention.

FIG. 1 is an oblique view of a system in accordance with the present invention.

FIG. 2 is an illustration of a screen on a display device, for providing movement cues and feedback to maintain desired exercise intensity.

FIG. 3 is an illustration of a screen on a display device, for providing movement cues and feedback to maintain desired exercise intensity.

FIG. 4 is an illustration of a screen on a display device, for providing movement cues and feedback to maintain desired exercise intensity.

FIG. 5 shows a plot of the targeted pace of work. In this graph, the METs (“Work”) required by the system increases by 3 METs every 30 seconds.

FIG. 6 is a dial-type graph that shows the prompted pace of subject's work in the center as being 15 METs. The arrow shows the current work level achieved by the subject. In this graph, the subject is in compliance with the prompt by moving at 15 METs.

FIG. 7 is a dial-type graph that shows the prompted pace of subject's work in the center as being 15 METs. The arrow shows the current work level achieved by the subject. In this graph, the subject is moving too slowly, at 12 METs, to be in compliance with the prompted movement rate.

FIG. 8 is an illustration of a screen on a display device, for providing movement cues and feedback to maintain desired exercise intensity and moment-to-moment changes in location. This illustration shows the dial-type meter, which fluctuates sporadically so that the subject has to continually and intermittently stop and start and adjust his pace and his moment-to-moment location to meet the prompted pace of the meter. In this illustration, the subject is moving at the prompted movement rate and prescribed direction, and is in compliance with the system requirement.

FIG. 9 s an illustration of a screen on a display device, for providing movement cues and feedback to maintain desired exercise intensity and moment-to-moment changes in location. This illustration shows the dial-type meter, which fluctuates sporadically so that the subject has to continually and intermittently stop and start and adjust his pace and his moment-to-moment location to meet the prompted pace of the meter. In this illustration, the arrow on the meter is showing the subject as moving at 12 METs, rather than at the 15 prompted by the system. He is moving too slowly to be in compliance with the system requirement.

FIG. 10 is a graph showing a simple pseudo-random pattern of work/demand required by the system. The pattern is repeated every 2 minutes in this example, but is complex enough that the subject is not likely to recognize the pattern.

FIG. 11 is a graph showing a more complex and physically demanding pseudo-random pattern of work/demand required by the system. This pattern is shown to repeat every 3:30.

FIG. 12 is a graph showing the more complex and physically demanding pseudo-random pattern of work/demand illustrated in FIG. 11. It is overlaid with a dotted line representing the subject's actual work in response to the system requirement.

### DETAILED DESCRIPTION

Known Dual Task (“DT”) paradigms fail to recreate the cognitive and motor/movement challenges inherent in dynamic environments that include reaction based sports such as football, basketball and similar. Nor do known DT paradigms provide the metrics/analytics to characterize a subject's cognitive and motor capabilities under “game conditions.” For data that may improve detection of a subject's increased risk of orthopedic injury or of overtraining syndrome.

Reaction-based sports challenge the athlete's/subject's cognitive, sensory, and neuromuscular systems. These three systems must be assessed concurrently. There is considerable research that supports this concept. For example:

“With the recognition that functional performance (“movement”) is the observable end result of the interaction of three system processes: muscular, sensory, and cognitive, 1 the assessment of movement should involve techniques that address all three systems.” Footnotes 2 3 4

“ . . . While single-task paradigms effectively measure either cognitive functioning or postural control, these paradigms may be limited as they only evaluate domains in isolation and not the interaction of these domains across concurrent tasks. Performance in sport requires simultaneous processing of cognitive, sensory, and motor information. A paradigm including concurrent assessments of these domains is needed to understand capabilities related to complex tasks.” (This quote was extracted from “Balance and cognitive performance during a dual-task: Preliminary implications for use in concussion assessment”, by Kevin M. Guskiewicz et al.

The methodology employed in this study has the subject read a word printed on a sign out-loud as the subject ambulate across a room. Other known Dual Task paradigms have the subject walking up stairs while tasked with counting down by 3 s out loud. Examples of DT paradigms that that appear to have little fidelity with reaction-based sports and other dynamic environments.

It is believed that an improved DT paradigm, one with improved measurement sensitivity, novel analytics in addition to greater fidelity with dynamic real world environments may improve the detection of symptoms of overtraining syndrome, and the increased risk of orthopedic and brain injuries. It may also contribute to the rehabilitation process for both assessment and rehabilitation, as well as for performance enhancement and assessment tool for healthy populations.

The present invention teaches novel application of the “interactive” or “virtual” simulator taught in '619 to challenge the subject's “cognitive, sensory and motor” capabilities by simulating the challenges of physically demanding work environments, as well as the activities of daily living for physically compromised/aging populations.

The present invention differs from known DT paradigms in a number of fundamental ways including the introduction of an exertional (aerobic and anaerobic) component to challenge the subject's cardiorespiratory system. The present invention acts to elevate the subject's heart rate to those experienced in reaction-based sports by prompting the subject to respond to spontaneous 3-dimensional movement cues. This is in sharp contrast to DT paradigms that display placards (signs) whose content is to be read out loud, i.e. the Stroop Test as the subject walks by said signs.

The scope of the present invention is not limited to athletic populations, but rather may benefit most weight bearing populations. Persons moving within their environment; whether athletes on the field or court or geriatric patients ambulating across their room, must, based on their visual observation, endeavor to safely navigate their movement path. And in many cases, they must also simultaneously “modulate/control”, either purposely or subconsciously, the rate at which they move.

### 1st Embodiment

By way of example, a football running back carrying the ball will continuously select a movement path, based on his visual observation, that offers the best opportunity to gain maximum yardage. At times, the player may also modulate his forward speed to elude tacklers or “wait” for his blockers to “clear” his path. The same paradigm may apply to a basketball player driving to the basket to score. Or the senior citizen avoiding her cat as she moves from the sink to the table.

Initially it was the intended purpose of the Graded Test taught in '619 was to replicate the uniform, predictable progression of exercise intensity employed with treadmill cardiac stress tests. It was unexpectedly discovered that this graded test also enabled a novel and remarkably efficacious Dual Task Paradigm (Divided Task). One that more precisely replicates real world challenges/tasks than known DT paradigm methodologies. It also generates previously unavailable data/analytics with clear benefits for improved assessment of broad weight bearing populations.

This first embodiment incorporates the graded protocol taught in '619 application.

As will be discussed in further detail this dual task paradigm embodiment provides visual cues that prompt the subject to move progressively faster in a predictable fashion while simultaneously moving to the correct targets. Like driving a car, the subject must continually follow the prescribed path and must also maintain the “displayed” movement speed as it progresses.

Over time, the subject's ability to successfully achieve increasingly more challenging stages (levels) of performance delivered by the present invention's dual task paradigm may provide objective evidence of improvement in their recovery or other outcomes of interest.

The subject's percentage time in compliance, the degree of compliance, as well as other metrics discussed below can be compared to either established normative data or the subject's previous assessments to assist in determining performance trends that may illuminate actionable or non actionable performance differences or deficits.

Peak heart rate, movement speed and Work Rate (METs, etc.) achieved could then be compared to the subject's Dual Task performance to provide the estimated cost of the single task vs. a dual task paradigm.

This method of progression is analogous to a treadmill graded test that acts to progressively increase the work rate in a predictable manner to the subject. The subject's peak performance, such maximum running speed is only known at near termination, i.e. failure. The subject's efforts up to this time may serve as a warmup, among other factors.

Similarly, in this embodiment the subject's movement performance is typically maximal only at near the subject's termination (exhaustion) point. Such maximal performance-related data can be invaluable to determine progress and existing deficits for performance enhancement, injury prevention and in rehabilitation

The Graded Test taught in '619 creates a novel DT paradigm by prompting a subject to move moment to moment at the prescribed movement rate to virtual targets that correspond to physical locations in the real world.

This Graded Test taught in '619 displays to the subject visual cues that are predictable in that these cues prompt subject movement at progressively faster movement rates, thereby progressively and predictably increasing the subject's work rate until termination.

In this first embodiment the subject may be instructed in advance that the movement rate will progressively increase until termination either volitionally due to fatigue, or compulsory because of the presentation of symptoms or other factors.

The subject's compliance with this progressive increase in the prescribed movement rate may serve as an indicator/marker of the subject's cognitive and physical response to the cognitive and physically demanding components of this novel Dual Task. The percent time in compliance and the degree of compliance as well as other metrics can be compared to either previously collected normative data or previously administered assessments of the subject to assist in determining trends that may indicate actionable or non actionable performance differences/deficits.

This novel Dual Task Paradigm demonstrated improved fidelity with reaction-based sports and other physically challenging environments, generating previously unavailable analytics to assist in the detection and characterization of symptoms of Overtraining Syndrome, increased risk for orthopedic and brain injury, as well as maladies that have the potential to diminish one's navigational/movement capabilities.

There are material differences between this graded test (′619) that enables a novel DT paradigm that distinguish it from the known prior art:

In contrast to many DT paradigms that present visual and/or auditory cues/tasks that are episodic (sporadic/periodic) in their presentation, TRAZER's Graded Test presents visual cues that are typically continuous in their delivery. This novel DT is somewhat analogous to driving a car where the driver must maintain the prescribed speed limit as well as continually point the car in the correct direction. These two distinct challenges require essentially constant cognitive involvement on the part of the driver; for example, a fatigued or intoxicated driver may find execution of such a divided task quite challenging and even dangerous as it requires maintenance of concentration and diligence.

With the present invention's DT paradigm, two distinct, but related visual cues create a Dual Task Paradigm that more precisely replicates real world challenges. TRAZER's DT is, by its very nature, analogous to a subject's ability to successfully navigate his or her environment, regardless of whether the subject is a geriatric patient, a wounded warrior, or a competitive athlete. Plus, it generates unprecedented data via the ability of TRAZER's position tracking movement capabilities to simultaneously measure the subject's moment to moment full body physical response.

In contrast to DT paradigms that present visual and auditory cues/tasks that are episodic in nature, such as the subject's reading of a sign (i.e. the Stroop Test) as the subject walks by, or the subject stands on a static balance device, the present invention presents visual cues that are continuous in their delivery, multi-directional, and are, by their very nature, fundamental to the ability of a subject to successfully navigate his or her environment where multidirectional movement is required.

This novel DT paradigm assess two fundamental capabilities inherent in this protocol:
The subject's assumption and maintenance of the correct movement distance and direction, and
The maintenance of the prescribed movement rate through execution of the protocol.

These DT paradigm assessments could be repeated periodically to determine changes from a baseline test and/or normative data. Assessments could be performed every few days, weekly or less frequently. Comparing the results of such periodic assessments over time can provide objective data regarding the subject's performance capabilities, which may become compromised if the subject is presently suffering a state of overreach or overtraining, or if the subject has other types of impediments, such as orthopedic or neurological, to successful, safe and effective movement.

The subject's performance on the aforementioned assessments could also be compared to relevant normative data or a “healthy” baseline test when the subject was not suspected of suffering from Overreaching and/or Overtraining. Or for detecting a heightened risk for injury. This novel DT paradigm can be used to document the athlete/subject's current status relating to their training or rehabilitation, thereby assisting in determining the degree of recovery and/or progress for improved management of exercise prescriptions. This novel data may also contribute to concussion management programs as well as orthopedic injuries or diseases.

For program management, this novel Dual Task Paradigm (“Divided Attention”) may deliver an appropriate 3-6 minute programmed “warm-up” that may elicit from the subject abrupt, aggressive changes in movement speed and perhaps movement direction that act to more profoundly challenge the subject's sensory, cognitive, cardio-respiratory and musculoskeletal systems.

Thus this invention serves to measure a subject's performance capabilities as well as detect any movement performance abnormalities and weaknesses that may be material to the subject's recovery for the management of fitness, performance enhancement or rehabilitation programs.

This novel DT paradigm may calculate the accumulated time that the subject remained in compliance with the prescribed movement rate and also moved in the correct direction, i.e. the total time the subject was moving at the prescribed rate and prescribed direction. For example, assume that the duration of the assessment was 7 minutes, 34 seconds (7:34) before termination, and that the subject was in compliance with the prescribed movement speed for 3 minutes and 14 seconds. The percent time in compliance could be calculated as a percentage of the total time for example.

This percentage of time in compliance can be compared to previous assessments or to normative data. For example purposes only, a healthy athlete may be in compliance for 78% of the assessment time, compared with 47% of the assessment time when the athlete is suspected of being in a state of Overtraining or exhibiting signs of an orthopedic issue. And the subject's movement data under higher stress movement scenarios may be revealing of asymmetrical movement patterns that may indicate a training effect, the presence of an injury, etc. by eliciting higher levels of cognitive and physical stress.

This data could be presented in a graphical format with Time along the X axis and Percent Compliance along the Y axis. One plot (line) would represent perfect compliance and a second line would represent the subject's actual (measured) compliance. The difference between these lines may illustrate/document the degree of non-compliance with the assessment protocol.

Also calculated and presented may become a comparison between the subject's time in compliance at various prescribed movement rates. By way of example, it may illustrate/depict that the subject was in compliance 67% of the time at slower movement speeds in contrast to 39% of the time at higher speeds.

The number of vector directions that may be reported may include as few as two to as many as 8 or more.

Such DT paradigm assessments may be performed to establish a healthy baseline, i.e. when the subject is not in an overtrained state, or to assist in establishing whether an apparently healthy subject is free of orthopedic injuries or similar. They may also be used to track improvement in a rehabilitation program of any nature, or the degree of regression during a chronic illness.

TRAZER's graded exercise test measures both functional cardio-respiratory and kinetic (movement) performance. It provides a novel, objective outcome measure of the subject's global performance capabilities. Data that is uniquely relevant to the patient, physical therapist, physician and trainer.

This DT task paradigm simultaneously challenges the subject's muscular, sensory, and cognitive systems for a more actionable and functional measurement of performance. It also challenges the cardiorespiratory system to assist in determining the subject's capacity to successfully and safely resume daily activities.

In a realistic context, this DT paradigm assesses performance of the complex tasks. Cardiac function is measured during interactive, 3-dimensional movements in real-time settings. Measurement of reaction time and decision-making skills is made possible by the presentation of spontaneous visual cues, in sharp contrast to the predictability of preplanned tests. To characterize “kinetic” health, the present invention measures and reports moment-to-moment reaction time, acceleration, speed, deceleration and distance traveled in each movement vector. Physiological parameters measured and reported include heart rate by telemetry and work rate expressed as METs.

The present invention characterizes exercise capacity (cardiorespiratory status) by reporting in “metabolic equivalents” (METs). Heart Rate response to increasing work is reported. Heart Rate and Work Rate provide novel and meaningful data regarding the subject's heart rate at each work rate during the test. If, for example, the subject's heart rate at a given work rate is exaggerated or blunted, it will be clearly evident.

Measured degradations in these aforementioned measurements in comparison to a previous baseline test and/or other prior subject assessment(s), or to normative data may be indicative of a state of overtraining, increased risk of injury or other undesirable states/conditions.

HEART RATE and WORK RATE provide novel and meaningful data regarding the subject's heart rate at each work rate during the test. If, for example, the subject's heart rate at a given work rate is exaggerated or blunted, it will be clearly evident.

Reaction Time versus Time is reported in hundredths of a second: TRAZER TEST measures the elapsed time from the presentation of the visual cue until the initial movement in the correct direction. Reaction Time is averaged for 30 second time periods and displayed vs Time or using “cycling” of the prescribed movement rate and direction.

Aligning these values alongside the METS vs. TIME curve may allow determination of the effects of progressive work efforts on the subject's ability to react. The measurement of reaction time may show the degradation of attention span, and is cited as a key indicator of a subject's propensity to fall in geriatric populations.

The scope of the present invention may not be limited to sports, but rather all weight-bearing populations. (Note that the present invention may also be applicable to certain wheelchair-bound populations as well.) If fact, populations ranging from those suffering brain injury or disease to movement disorders in geriatric populations all benefit from the introduction of multiple sensory “challenges” that challenge (use “test” or “strain” instead of challenge?) and assess the subject's processing power (cognitive reserves) as well as physical movement performance.

The scope of the present invention may not be limited to sports, but rather all weight-bearing populations. (Note that the present invention may also be applicable to certain wheelchair-bound populations as well.) If fact, populations ranging from those suffering brain injury or disease to movement disorders in geriatric populations all benefit from the introduction of multiple sensory “challenges” that challenge (use “test” or “strain” instead of challenge?) and assess the subject's processing power (cognitive reserves) as well as physical movement performance previously discussed, the accumulative effects of training and competition place the athlete periodically in the state of overreaching, accompanied by risk of overtraining, resulting in diminishment of the athlete's performance capabilities; i.e. “disruptions in multiple physiologic systems.”

Does this diminishment of performance place athletes at increased risk of brain and orthopedic injury as a result of Overtraining?

Characterizing whole body recovery/response to the current novel Dual Task paradigm provides previously unavailable critical data to more effectively manage the stress-regeneration cycle as well as detect heightened risk for orthopedic or brain injury. In contrast to tests not accounting for the influence of increased metabolic activity, the present invention's continuous measurement of heart rate and movement speed at progressively higher metabolic rates characterizes the subject's work capacity. And reaction time to spontaneous visual cues assesses cognitive function under game conditions.

Such assessments generate previously unavailable data regarding the status of the athlete's stress-regeneration cycle for the purpose of reducing the risk of injury resulting from the modifiable degradation of sport-specific performance capabilities. To provide a novel marker of whole body recovery for exercise prescription management. Diminishment of reaction times and accelerations, as well as an exaggerated heart rate for a given work load compared with baseline tests may expose (detect) early fundamental signs of increased risk of Overtraining.

It is important to note that this invention elicits subject responses to cognitive challenges at varying metabolic (work) rates (these prompted work rates are typically unpredictable to the subject) to objectively document increasing physical stress on cognition (as measured by reaction time and movement accuracy) and well as the resulting effects on the subject's accelerations, movement speed, decelerations in a variety of movement vectors that may range from as few as two to as many as eight movement vectors.

TRAZER's visional cues/prompts act to simulate the cognitive and physical demands of reaction-based sports that include the abrupt/violent changes in direction as an athlete responds to game play. For example, a football defensive back responds moment-to-moment to the receiver that he is guarding.

The resulting characterization of the athlete's whole body response to simulated game play provides a novel measure of the accumulative potentially deleterious effects of training and competition. Unlike the results of currently available tests of isolated capacities, this approach more accurately characterizes real-world performance, eliciting information that is directly transferable to reaction-based sports and other potentially physically demanding environments.

The progressive increase in Work Rate, which is derived from the movement rate of the subject, measured in METs or equivalent, can also serve to gauge the subject's response to more physically demanding dual tasks. With this embodiment this progressive increase in the prescribed movement is known to the subject.

This aforementioned prompting is accomplished by the appearance of virtual targets that corespondent with locations in the real world. This presentation of two distinct, but related tasks creates a novel DT paradigm.

In some applications, the present invention may essentially function as an approx. 3-8 minute sport-specific, computer-controlled “warm-up” that characterizes the athlete's/subject's cognitive and motor response to training or other physical stressors.

Applications range from, but are not limited to, healthy athletic populations to weight bearing geriatric populations as well as orthopedic and neurological rehabilitation. Some examples include:
Screen for early signs of overtraining to more effectively manage exercise prescriptions.
Detect movement deficits to improve performance and reduce the risk of orthopedic injuries.
Assist in ensuring satisfactory return from injury.
Gauge sport-relevant cardio respiratory fitness
Personalize training programs according to each subject's exercise tolerance.

This Dual Task Paradigm can characterize the subject's ability to successfully navigate his or her environment based on visual observation, regardless of whether the subject is a geriatric patient, a wounded warrior, or a healthy or injured athlete.

THERE IS a clear distinction regarding how this first embodiment progressively increases the subject's movement rate and known movement-oriented video games. Interactive fitness video games typically control the player's movement rate by modulating/controlling the rate at which visual movement cues/prompts are presented to the player via the display.

For example, if the objective of an interactive fitness game is to prompt the real world player/exerciser to move faster in a given vector direction, the virtual game cues/prompts may therefore move correspondingly faster in this desired movement direction. Accordingly a virtual tennis game designed for the Microsoft Kinect may prompt the real world player to move in a manner analogous to real world tennis, i.e., the virtual tennis ball would be “placed”/“hit” to the area the real world player is to be “relocated.”

In sharp contrast, the Graded Test taught in '619, is distinct from the aforementioned approach in that the displayed (prescribed) movement rate is independent of the rate at which the virtual targets/designations are displayed.

For example, the virtual targets may appear and reappear at high or low frequency in a variety of locations in the virtual world, while the rate at which the subject is prompted to move to said virtual targets is governed solely by the interactive sports simulator taught in '619 displayed movement speed meter. To follow a protocol/assessment the subject must be attend to two distinct tasks, with the result a novel DT paradigm with greater

### 2nd Embodiment

In contrast to the first embodiment, this second embodiment provides visual cues that prompt movement rates that may appear to the subject to either be unpredictable or predictable in duration as well as magnitude of the speed prompted.

This appearance of randomness acts to further challenge the subject's cognitive prowess (reserves) as well as placing additive stress on the subject's movement capabilities.

Another variation of this novel DT paradigm that, in addition to prompting a predictable progression of the subject's movement rate, may also prompt movement rates of varying speeds that may appear unpredictable to the subject. In other words, the subject may be prompted to move faster or slower as the protocol progresses and in a manner that appears to the subject to be unpredictable.

This second embodiment of the present invention acts to progress the subject's movement rate in what appears to be unpredictable fashion. The subject may be challenged via bouts (episodes) of slower movements interspersed with bouts of faster movement efforts.

The changes in the prescribed movement speed may appear to the subject to either be unpredictable or predictable in both the duration and the magnitude of the movement speed prompted. This appearance/perception of randomness may further challenge the subject's cognitive and motor prowess (reserves).

This periodic modulation of the prescribed speed in a pseudo random manner is believed to necessitate greater concentration/focus on behalf of the subject. The subject's actual compliance with this novel DT paradigm may be compared to “perfect” compliance; a score representing the difference over time between the subject's actual degree of compliance and a perfect level of compliance. The subject's score could also be compared to normative data and/or previous tests by the subject.

This second embodiment differs from the first embodiment in that the first embodiment may only create an opportunity to assess the subject's maximal effort only when the subject is near or at the the point of volitional termination.

In contrast, this second embodiment may create a number of opportunities to assess the subject's maximal performance status; this is accomplished by prompting a series of maximum or near maximum efforts by the subject interspersed with period of lesser demands that may aid the subject in regaining his stamina. This unpredictably from the perspective of the player is analogous to actual game play.

The availability of a larger number of samples of the day subject's near maximum or maximum efforts is believed to provide for more sensitive and accurate protocol for the detection of movement deficits; deficits that may be masked at lower movement rates (stress levels) but become evident at higher stress levels.

To further increase the visual, cognitive and movement (motor) challenges, in contrast to the aforementioned predictable progression of the exercise intensity that may be known in advance by the subject, this second embodiment may deliver movement cues to the subject that are not easily predictable or anticipated by the subject.

For example, the prescribed movement rate may vary in ways that include prompting changes in the pace of movement—prompting either faster movement rates or slower movement rates. Such prompting could also include prompting in a manner that may be either predictable or unpredictable to the subject. Also the duration of any such slower or faster movement pace may be predictable or unpredictable to the subject. These changes in movement pace or direction may become “explosive” to mimic the cognitive and motor stresses of actual reaction-based sports.

It is believed that the aforementioned combinations of predictable and/or unpredictable prompting of variations in the prescribed speed may require greater concentration/focus on behalf of the subject in order to remain compliant with the prescribed movement rate. And that it will produce higher physical stress levels, that may detect movement deficits that relate to the health and conditioning of the subject's knees and ankles.

As such, this prescribed apparent (pseudo) randomness may further challenge the subject's cognitive prowess (reserves); it may also act to increase the subject's physical performance challenges as the subject may be subject to frequent and aggressive changes in movement direction and speed which may appear to the subject as unpredictable. This protocol may be analogous (similar) in its cognitive and physical demands to those of a defensive player guarding his/her offensive opponent, where the defensive player must react (anticipate and react) to the offensive player's actions.

The following teaches how this novel Dual Task Paradigm “abruptly” challenges the subject's movement capabilities to further improve measurement sensitivity and novel analytics. Though an important application for this presents invention is sports/athletics, this protocol is applicable to populations that include geriatrics (aging populations), orthopedic and neurological patients. For these populations the amplitude (the work rates) are sufficiently dampened to so accommodate.

It must be noted that this imposed abrupt/“violent” changes in movement direction provides many more opportunities for sampling the key measurements discussed herein. A traditional graded test, whether implemented via a treadmill or with the present invention (sports simulation) challenges the subject (i.e. elicits maximal effort) in many cases to make a maximal effort, for the test duration to approach or reach a state of volitional termination by the subject; that point in time that the subject is making a maximal efforts. With the the second embodiment of the present invention, the subject is prompted to undertake maximal accelerations, decelerations et al periodically (sporadically) throughout the protocol/test. The result is more samples/data points to process.

In this disclosure, two embodiments of a novel Dual Task paradigm have been described.

In the system 10, the athlete's perceptual (sensing) ability is not tested in isolation, but rather as the initial stage of a continuum of capabilities ranging from the ability to recognize and interpret sport-relevant visual information, to the ability to adeptly execute, when desired, in a kinematically correct manner. The athlete's visual and cognitive skills are challenged by sensing and responding to sports simulations that demand the athlete undertake the “correct” pursuit angle.

The approach described herein uniquely challenges the athlete's sensory, vestibular (balance) and orthopedic systems. With the system 10, the athlete responds with rotations, translations and vertical changes of body position to undertake the “correct” pursuit angle. This pursuit angle is known to the system 10. Unlike static balance tests, aspects of depth perception, dynamic visual acuity, peripheral awareness and anticipation skills are assessed during realistic movement.

Also material to test validity is the unpredictability of the stimuli delivered to the athlete over multiple tests and within the same test. Randomizing software algorithms may be used to ensure that the athlete cannot correctly anticipate subsequent movement challenges. This pseudo-randomization may present varying levels of challenge, demanding very low work rate levels and minimal changes in pace for those rehabilitating, or those who are cognitively or orthopedically challenged, to demanding a very high work rate level (METs) and sharp, spontaneous changes in pace and direction of movement.

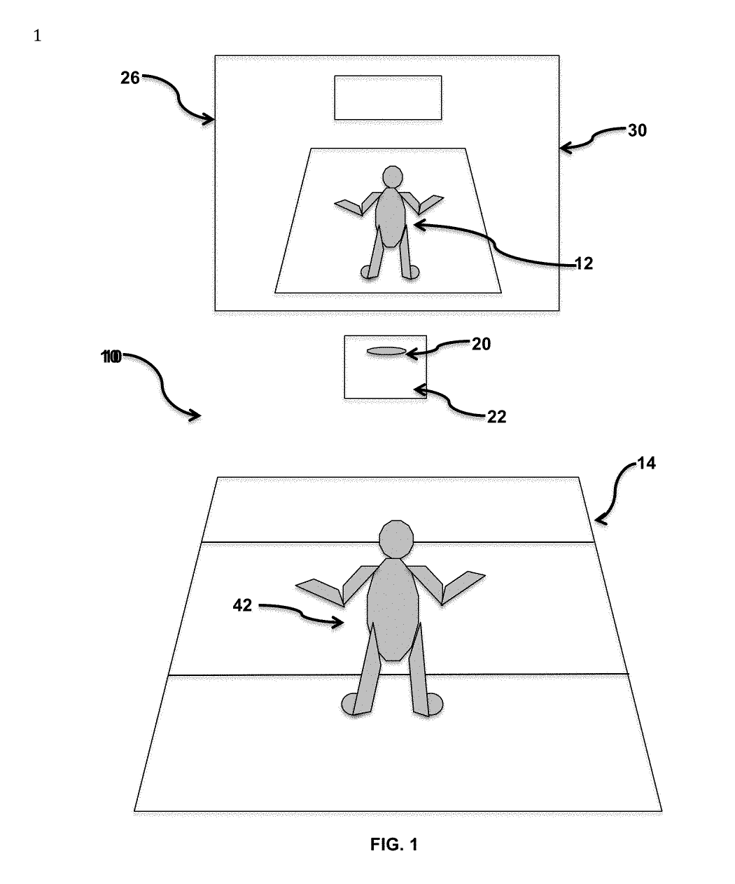

FIG. 1 shows an example of a system 10, in some ways similar to the TRAZER system, which prompts full body movement of a person 42, in a physical space 14, which may or may not be visually delineated, and which need not have definite boundaries. Movement of the person 42 is detected and tracked by a camera or other sensor 20 in a base unit 22, which may include other components such as a processor, communication ability, data storage, etc. The camera or other sensor 20 may have an adjustable field for tracking the person 42, for example be adjustable to track in an area range from 36 square feet to 400 square feet. A display 26 is used to display a view 30 to the user 42, or to otherwise prompt full body motion to be tracked by the base unit 22. The view 30 may show an avatar 12 that represents movement of the user 42 in the physical space 14.

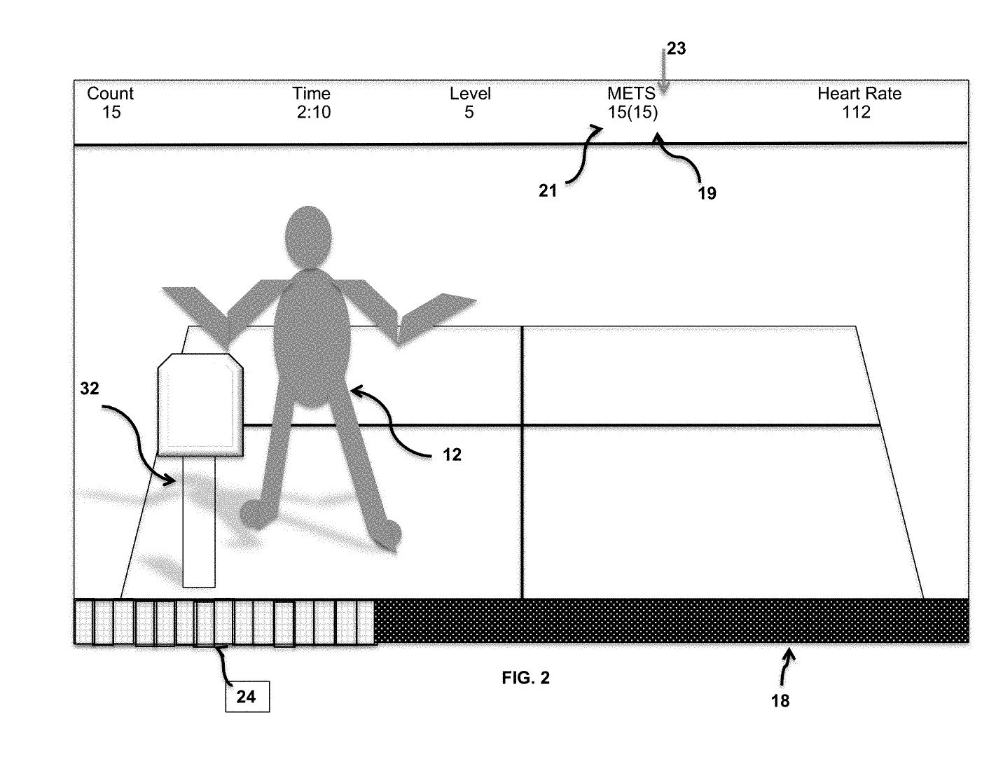

FIGS. 2, 3 and 4 show two mechanisms that may be used to deliver to a test subject visual feedback regarding work rate or work load of the exercise that the subject is engaged in. In cardiac exercise (stress) tests employing a treadmill control (increase the work rate) the load is imposed on the subject by increasing the speed of the treadmill platform and/or the incline of the platform. With the increase in load, the subject needs sufficient exercise capability to assume and maintain the new work rate (load) or the test is terminated. This approach can be characterized as externally imposing the load on the subject so as to test his tolerance for exercise.

However, in contrast to the aforementioned externally-imposed load cardiac exercise tests, the testing described earlier herein relies on the subject's “volitional control,” the subject's compliance with the prescribed work rate (the pace of the test protocol). To maintain the current pacing (work rate), it is advantageous that the subject be provided with essentially real time feedback regarding his or her performance. The feedback can be, for example, in (and/or based on) METs, calories, speed or similar metrics related to work rate. Such feedback informs subjects whether they are moving too fast or too slow.

FIG. 2 shows one example of a combination of analog 18 and digital 23 work rate meters that tell the subject his targeted work rate in METs. The digital meter at the top of the screen shows the desired METs in parentheses 19, and the METs achieved 21 to the left of the parentheses. At the bottom of the screen, an analog meter shows in lit segments a bar with the number of METs achieved 24. The meters may be provided with colors and/or textural markers, providing information to the test subject. The meter may have visual effects when the subject's work rate is outside of the desired target zone, for example flashing when the work rate is too high or too low, to act as an alert to the subject.

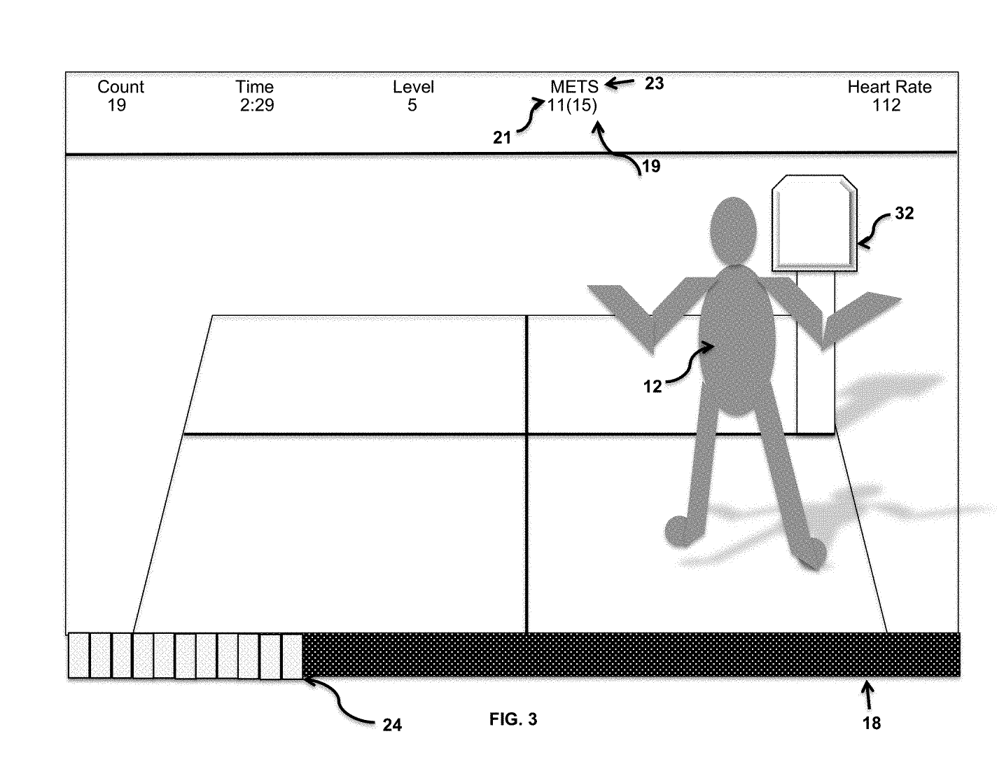

FIG. 3 shows another example of a combination of analog 18 and digital 23 work rate meters that tell the subject his targeted work rate in METs. The digital meter at the top of the screen shows the desired METs in parentheses 19, and the METs achieved 21 to the left of the parentheses. At the bottom of the screen, an analog meter in lit segments a bar with the number of METs achieved 24. In this example, the subject is performing at less than the desired work rate, as shown by 21 and 24.

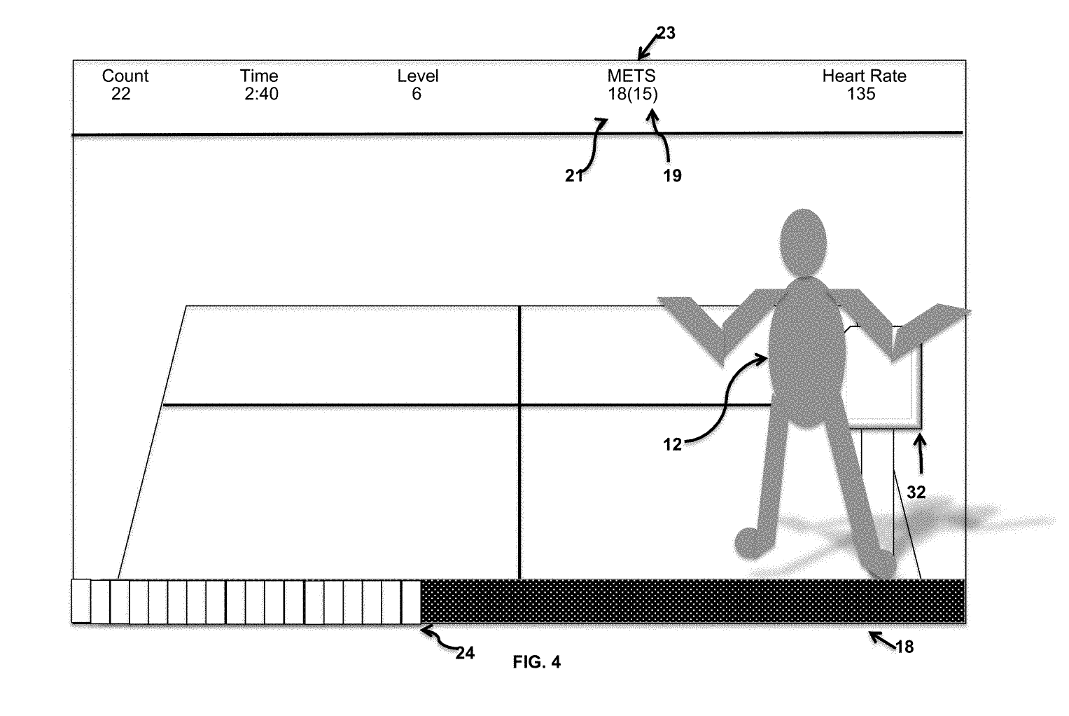

FIG. 4 shows another example of a combination of analog 18 and digital 23 work rate meters that tell the subject his targeted work rate in METs. The digital meter at the top of the screen shows the desired METs in parentheses 19, and the METs achieved 21 to the left of the parentheses. At the bottom of the screen, an analog meter shows in lit segments a bar with the number of METs achieved 24. In this example, the subject is moving faster than the desired work rate, as shown by 21 and 24.

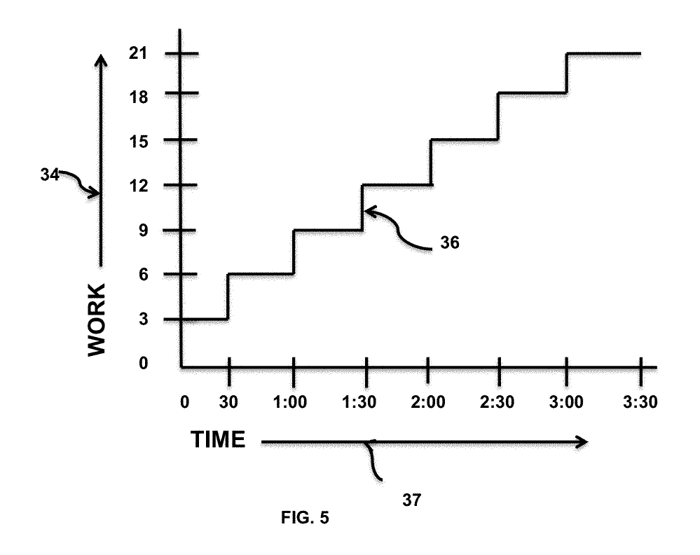

The control of exercise intensity is not based on heart rate, but may be based rather on a measure of “work rate” expressed as METs derived from realtime momentto-moment positional changes in response to the system's interactive cueing, each from speed of movement during the positional changes, and distance of the positional changes. The first Dual Task embodiment controls (modulates) the progression from low to high exercise intensity as shown, by example, in FIG. 5, wherein the work rate, shown on the Y axis, elevates by 3 METs 34 every 30 seconds 37, shown on the X axis, in this example. This controlling (modulating) of the progression from low to high exercise intensity provides a controlled profile of work rate versus time, in which certain other key variables can be compared/evaluated. The exercise intensity progression can be repeated for different assessments accomplished at different times. This graded progression of exercise intensity is analogous to that of the Bruce/Balke cardiac stress tests (performed on treadmills or other stationary exercise equipment), with one major exception. The planned, one-dimensional (stationary) exercise pattern of a treadmill or stationary bike, where the subject walks/runs in place as the belt speed and angle are progressively increased, is replaced by interactive, three-dimensional movement.

By using the system 10 to analyze movement capabilities in each vector direction, it has been found that orthopedic injuries, especially lower extremity injuries, often produce movement deficits in defined movement vectors. For example, moving off an injured right knee may inhibit reaction time and acceleration when the athlete is moving to the left, and may exhibit compromised deceleration capabilities when the athlete is moving to the right. Diminished reaction time as a result of an orthopedic injury may resuit from deterring pain, confidence and/or loss of proprioception; additionally, acceleration/rate of force production deficits may also be observed.

The ability to perform both of the above tasks simultaneously, maintaining the work rate demanded by the meter, and at the same time, recognizing and responding to moment-to-moment cues at the correct pursuit angle, is an example of dual tasking.

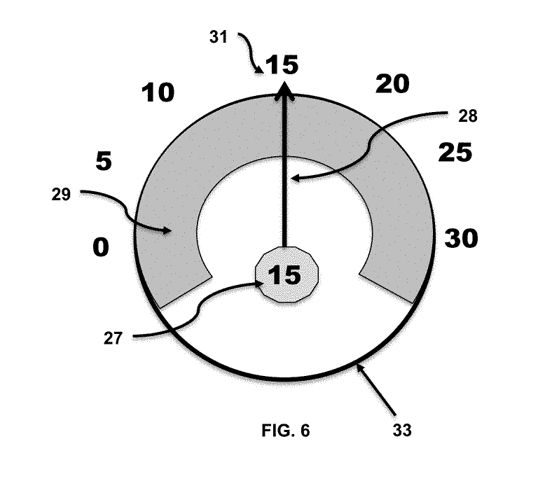

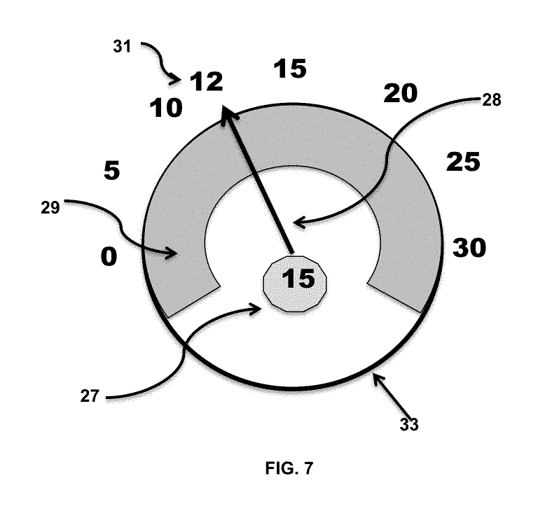

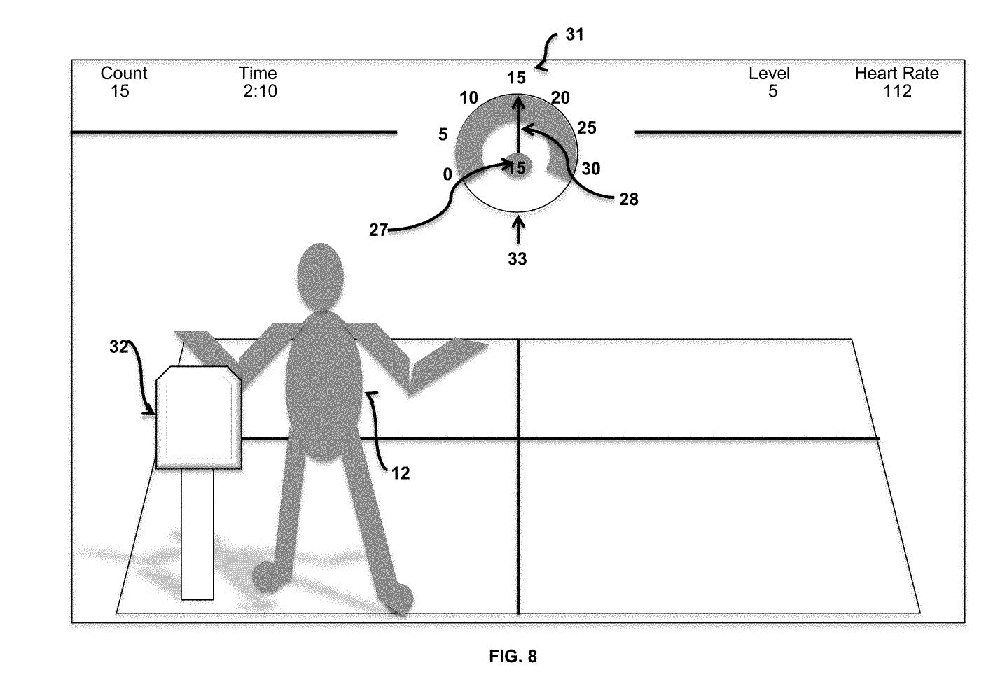

As discussed herein, the second embodiment of the Dual Task paradigm introduces unpredictability to the visual prompts. In this second embodiment of the Dual Task paradigm, a large meter 33, an example of which is shown in FIG. 6, is prominently positioned in the view 30 (See FIG. 8) in the virtual world that the subject is interacting with. The meter may be a dial, as illustrated here, or in another form that illustrates a prompted work rate. The meter 33 must have a means of displaying both the prompted work rate 27 and the moment-to-moment work rate achieved by the subject 31. In this example, the prompted rate 27 is displayed on a lit dial in the center of the meter. An arrow 28 points to the work rate achieved by the subject 31. A band inside the meter 29 may change colors or flash or otherwise provide feedback to the subject as regards his work rate. FIG. 6 illustrates a prompted work rate 27 of 15 METs 31, and the subject is in moment-to-moment compliance at 15 METs achieved. FIG. 7 shows the same meter as in FIG. 6, with the same prompted rate 27, but the arrow 28 shows that the subject is working below the prompted work rate at 12 METs 31.

This meter is used to cue the subject to make sporadic and instantaneous changes in pace. The meter may display a demand for 15 METs in one instant, 3 in the next, causing the subject to race to one target, suddenly brake, and walk slowly to the next. This spontaneous shift in pace/demand puts realistic, sport relevant stresses on many of the subject's systems, whether cognitive, orthopedic, vestibular or cardio respiratory.

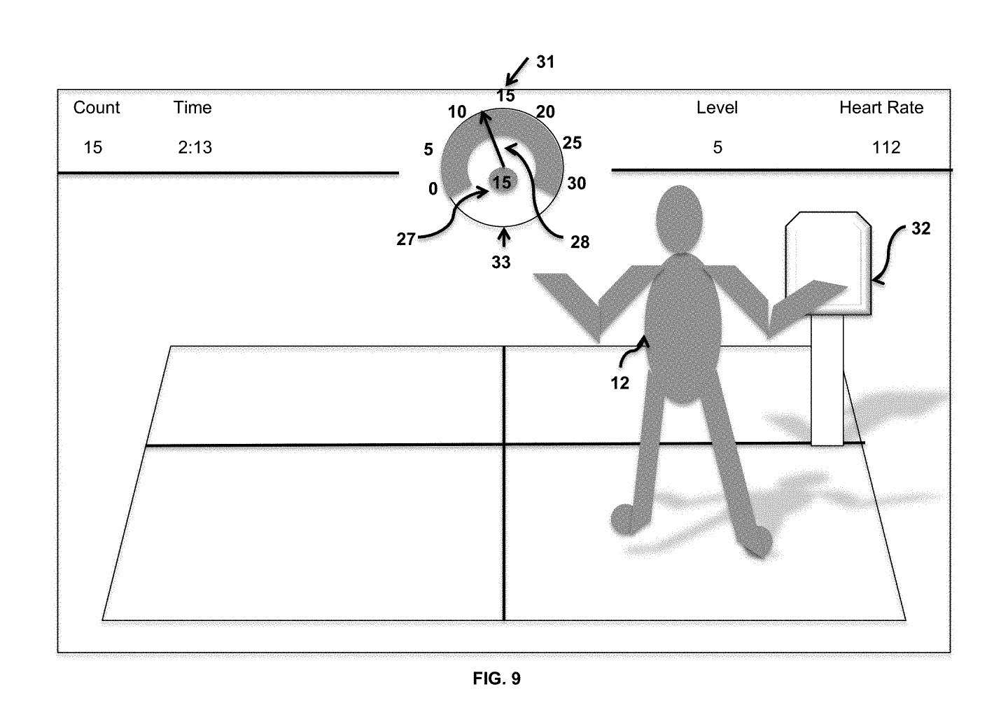

The subject's avatar 12 on the display screen 30 moves in one-to-one correspondence to the movement of the subject in the real world 42. FIG. 8 shows that the subject's avatar 12 has reached his target/cue 32. The meter 33 displays the target work rate 27 as 15, and the arrow 28 shows that the subject 12 work rate achieved 31 matches the target at 15 METs. FIG. 9 shows that the subject 12 has slowed down in his transition to the next target 32. The meter 33 displays the target work rate 27 as 15, and the arrow 28 shows that the subject 12 work rate achieved 31 is below the target at 12 METs.

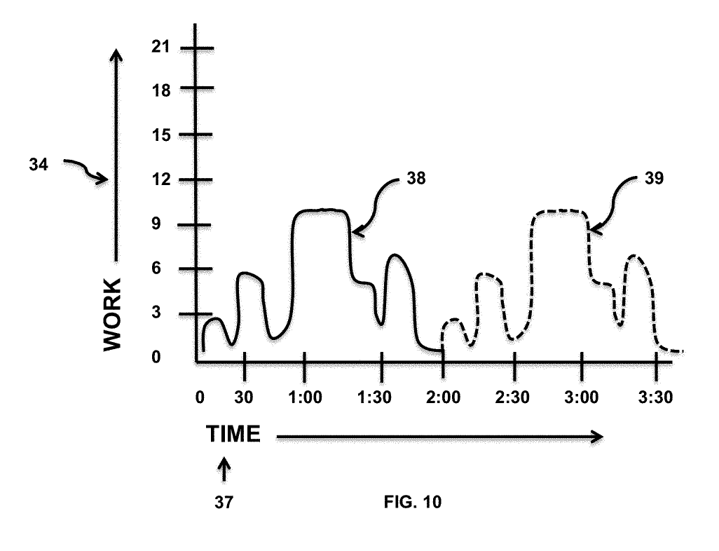

FIG. 10 shows one example of a pseudo-randomized pattern of work that can be delivered by the system 10. The work rate in METs is shown on the Y axis 34 and the time/duration of the test is shown on the X axis 37. In this example the pattern 38 repeats 39 after every 2 minutes, and requires approximately 1-2 changes in work every 30 seconds. Work is at no more than 9 METs.

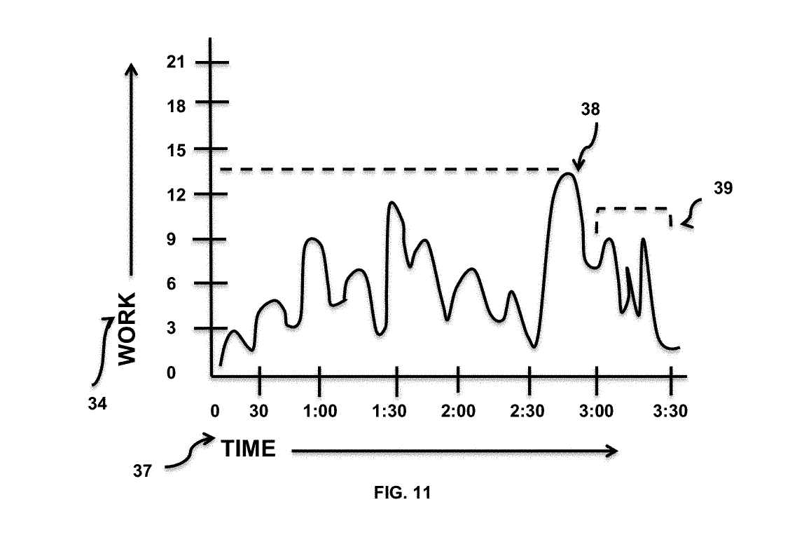

FIG. 11 shows a more complex example of a pseudo-randomized pattern of work that repeats every 3:30. In this example, there are up to 6 changes in direction 39 in a 30 second period, and the demand for work is up to 14 METs 38. This pattern represents a more challenging test for a conditioned athlete.

In order to be able to compare the subject's performance data from time to time, it is important to deliver the same pattern of movement for each and every test. This approach may capture a more accurate picture of the subject's cognitive, vestibular and orthopedic health.

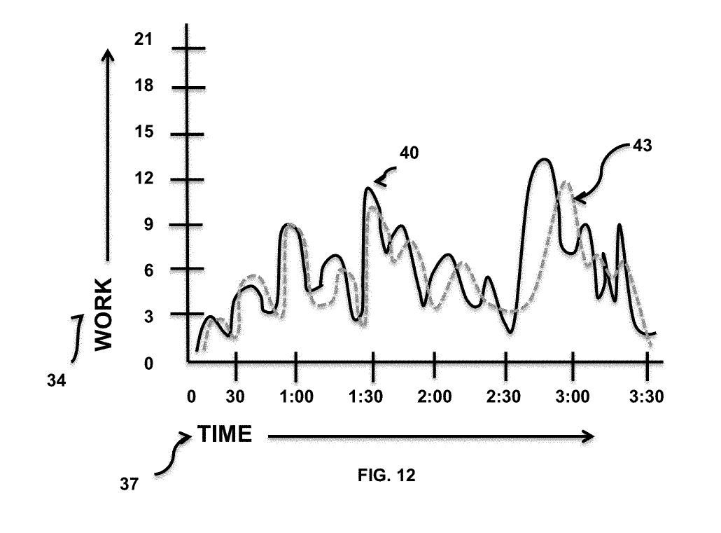

FIG. 12 shows a pseudo-randomized pattern of work in a solid black line 40, overlaid with the subject's pattern of work in a grey, dashed line 43. By overlaying the subject's pattern of work in this fashion, a visual picture can be derived of the percentage of compliance.

1. method of assessing a subject, the method comprising:
directing the subject to exercise by providing movement cues for whole-body translation movements, wherein the directing includes providing two types of visual feedback to the subject during the directing, for the subject to maintain compliance with a desired movement direction and a desired movement rate;
measuring subject response to the exercise; and
evaluating the measured subject response;
wherein the directing includes increasing the desired exercise intensity over time during a single exercise session by progressively increasing the movement rate; and
wherein the providing includes providing visual feedback to the subject during the directing, to prompt the subject to maintain movement speed, determined from a speed of movement of the subject, and to prompt the subject to maintain the prompted movement direction.
